(19) United States
(12) Patent Application Publication
(10) Pub. No.: US 2010/0229240 A1
(43) Pub. Date: Sep. 9, 2010

(54) LICENSE MANAGEMENT DEVICE AND CONTROL METHOD AND CONTROL PROGRAM OF LICENSE MANAGEMENT DEVICE

(76) Inventor: Motoshi Tanaka, Saitama (JP)

Correspondence Address: SUGHRUE MION, PLLC, 2100 PENNSYLVANIA AVENUE, N.W., SUITE 800, WASHINGTON, DC, 20037, US

(21) Appl. No.: 12/599,623

(22) PCT Filed: May 8, 2008
(86) PCT No.: PCT/JP2008/058521

§ 371 Date: Nov. 10, 2009

(30) Foreign Application Priority Data
May 14, 2007 (JP) 2007-127973

(51) Int. Cl. G06F 21/00

(52) U.S. Cl. 726/26

(57) ABSTRACT

A total time for license check communication processings can be reduced. A cellular phone 1 is a license management device managing one or more licenses of contents and including: a control unit 11 checking out a license of a content to a content provider via a wireless unit 14, the content which has a terminable license and is stored in an internal memory 12 and so on; and a liquid crystal display 19 displays results of the license check communication processings. In the license check communication processings, licenses are sequentially checked out to a plurality of content providers and the results are received. The liquid crystal display 19 displays the acquired results of the license checks in a list form, after the license checks are completed to all the content providers.

### FIELD OF THE INVENTION

The present invention relates to a license management device and a control method and a control program of the license management device, and more particularly, to a technique to reduce a time for license check communication processings.

### BACKGROUND ART

For example, a technique related to the present invention includes the inventions disclosed in the patent documents 1 to 3. The patent document 1, particularly in the paragraph 0074 and so on, discloses that a license manager receives operating information which is needed for a license check and is information on an application being a target to be managed, from a plurality of client PCs. The patent document 2, particularly in the paragraph 0043, FIG. 9 and so on, discloses that, when a user requests transmission of a download page, a soft distributing server searches for a license key which is corresponded to application software the user has bought until now and generates the download page to transmit to a user terminal. Also, the patent document 3, particularly in the paragraphs 0040 to 0042 and so on, discloses that a replay scheduling display displays a period during which each of contents can be replayed in a time line for a user to recognize a relationship of licenses of the plurality of contents.

Patent document 1: Japanese Patent Laid-Open Publication No. 2001-084137
Patent document 2: Japanese Patent Laid-Open Publication No. 2004-054324
Patent document 3: Japanese Patent Laid-Open Publication No. 2006-261904

### DISCLOSURE OF THE INVENTION

### Problem to be Solved by the Invention

In recent years, there are developed and commercialized cellular phone devices including a plurality of contents which have replay periods and are downloaded via a wireless communication network. Such cellular phone devices have a problem of license management of the plurality of contents. To check licenses of contents one by one, it is necessary to execute a license check communication (processing to determine whether the contract has been renewed or not, or whether the content is during a contract period or not) to companies which have provided the content (hereinafter, content provider) via a wireless network. Conventionally, there is the following problem about the license check communication.

That is, when the license check communication is completed to one content provider and its result screen is displayed before connection is established to the next content provider, there is a case where a cellular phone is left with displaying the result screen and the connection is disconnected. And consequently, it requires a more total time to complete the license check communication processings. However, the inventions in the patent documents 1 to 3 are not directly related to solving the above problem.

In consideration of the above situation, an object of the present invention is to reduce a total time for license check communication processings in a device which manages a plurality of licenses of contents using a license check communication.

### Means to Solve the Problem

In order to achieve the above mentioned object, a first aspect of the present invention is a license management device managing one or more licenses of contents, including: a license checking unit that checks out a license of a content by connecting to a content provider of the content via a communication; and a display unit that displays a processing result from the license checking unit, wherein, the license checking unit sequentially checks out the licenses to the plurality of content providers and receives the results and the display unit displays the results of the license checks acquired by the license checking unit in a list form, after the license checking unit completes the license checks to all the content providers.

Moreover, a second aspect of the present invention is a control method for a license management device managing one or more licenses of contents, including: a license checking step of checking out a license of a content by connecting to a content provider of the content via a communication; and a display step of displaying a processing result from the license checking step, wherein, the license checking step sequentially checks out the licenses to the plurality of content providers and receives the results and the display step displays the results of the license checks acquired by the license checking step in a list form, after the license checking step completes the license checks to all the content providers.

Moreover, a third aspect of the present invention is a control program which allows a license management device managing one or more licenses of contents to function as a license checking unit that checks out a license of a content by connecting to a content provider of the content via a communication; and a display unit that displays a processing result from the license checking unit, wherein, the control program allows to the license management device to execute: a processing of sequentially checking out the licenses to the plurality of content providers and receiving the results at the license checking unit and a processing of displaying the results of the license checks acquired by the license checking unit in a list form on the display unit, after the license checking unit completes the license checks to all the content providers.

### EFFECT OF THE INVENTION

According to the present invention, it is possible to reduce a total time for license check communication processings in a device which manages a plurality of licenses of contents using a license check communication.

### BEST MODE FOR CARRYING OUT THE INVENTION

Hereinafter, a detailed explanation of the preferred embodiment of the present invention will be described with reference to drawings.

### First Exemplary Embodiment

In a first exemplary embodiment, the present invention is applied to a cellular phone as one exemplary embodiment of a license management device, but, needless to say, the present invention is not limited to the present embodiment.

When executing a license check communication processing, a cellular phone 1 of the present embodiment does not display its result screen at the timing of completing the license check communication processing for one content provider (not a configuration displaying the results one by one). The cellular phone 1 automatically executes the license check communication processing to the next content provider and displays all the results of the license check communication processings together when the license check communication processings are completed to all the content providers. Thereby, a total time for the license check communication processings can be reduced and the results of the license check communication processings are displayed together in a list form when the license check communication processings are completed. Hereinafter, a configuration and an operation of the present invention will be described. FIG. 1 is a block diagram generally showing a primary configuration of the cellular phone 1 of the present invention.

As shown in FIG. 1, a control unit 11 is disposed in the cellular phone 1 and controls an operation of the whole cellular phone 1 according to various programs stored in an internal memory 12. The internal memory 12 stores the various programs and a content a user has downloaded from a content provider (not shown) on a network. Note that the cellular phone 1 may include an external memory 13. The external memory 13 stores the similar data as the internal memory 12 does and can be separated from the cellular phone 1.

For example, a wireless unit 14 includes an antenna and a transmission/reception unit, and communicates with a wireless base station. Received data includes audio data and a content a user has downloaded from a content provider on a network. The wireless unit 14 amplifies and demodulates the received data and then transmits to the control unit 11 as a received signal. This enables the control unit 11 to detect an incoming call and access to the content. When detecting the incoming call, the control unit 11 activates a speaker 16 and a vibrator 17 to inform the incoming call by the sound or the vibrator. When the user operates a key operating unit 18 to watch or listen to the downloaded content, the control unit 11 reads the content from the internal memory 12 to output a sound from the speaker 16 or a movie on a liquid crystal display unit 19.

The content the user has downloaded in the present embodiment can be watched or listened to by making a terminable contract with the content provider. The cellular phone 1 regularly (or when the user desires) needs to execute the license check communication for each content provider in order to renew the contract of such a content or check whether the contract period is expired or not. A detail explanation of the license check communication processing and user interfaces will be described below with reference to FIG. 2 and FIG. 3.

The control unit 11 checks out a license of a content stored in the internal memory 12 by connecting to a content provider which has distributed the content via a wireless communication using the radio, unit 14. That is, the control unit 11 functions as license checking means. Also, the liquid crystal display 19 displays a result of the license check communication processing executed by the control unit 11. That is, the liquid crystal display 19 functions as display means. Note that these functions are realized by a control program stored in the internal memory 12. The control program may be provided for the cellular phone 1 by the external memory 13 being a storage medium.

Next, an operation of the present embodiment will be described. A detailed explanation of the license check communication processing and user interfaces will be described below with reference to FIG. 2 and FIG. 3. FIG. 2 is a flow chart showing the operation of the present embodiment. The present embodiment operates according to the flow chart when the license check communication processing starts.

When the license check communication processing is executed for one content provider and completed (Step 1), the control unit 11 determines whether there exists a content provider for which the license check communication processing has not been executed yet (Step 2). When it is determined that there exists another content provider for which the license check communication processing has not been executed (Yes, Step 2), the license check communication processing is executed for the next content provider (Step 3). Steps S1 to S3 are automatically and sequentially executed without a user's operation.

After that, processings of Steps S1 to S3 are repeated. When it is determined in Step 2 that there exist no content provider for which the license check communication processing has not been executed (No, Step 2), the results of the license check communication processings are displayed on a list screen (Step 4).

FIG. 3 is a drawing which exemplifies user interfaces of the present embodiment and, particularly, user interfaces of the license check communication processing. During processings of Steps S1 to S3 of FIG. 2, the liquid crystal display 19 of FIG. 1 displays a wait screen shown in a screen 1 of FIG. 3. In Step S4 of FIG. 2, as described above, the results of the license check communication processings are displayed on the list screen. That is, a screen shown in a screen 2 of FIG. 3 is displayed on the liquid crystal display 19 of FIG. 1.

As described above, unlike a configuration which shows a result screen each time the license check communication processing is completed for one content provider, when the license check communication processings are executed for a plurality of content providers in the present embodiment, the license check communication processing is executed for the next content provider without requiring a user's operation after the license check communication processing is completed for one content provider. Moreover, when the license check communication processings are completed for all the content providers, the results of the license check communication processings are displayed in a list form as shown in the screen 2 of FIG. 3. Thus, the user can confirm on the list, whether contracts are renewed or not, after the license check communication processings are completed.

According to the present embodiment, it is possible to reduce a total time for the license check communication processings because it does not happen that a cellular phone is left as it is with showing a result screen after displaying the result screen of the license check communication processing for each content provider and its communication is disconnected. Moreover, the license check communication processings can be executed for all the content providers without requiring a user's operation. Moreover, a user can confirm the results of the license check communication processings in a list form after the license check communication processings are completed, which improves usability.

### Second Exemplary Embodiment

In addition to the configuration of the first exemplary embodiment, a second exemplary embodiment allows a user to select a content provider being a target of a license check before executing the license check communication processing. The present embodiment will be described with reference to FIG. 4. However, an explanation which is overlapped with the first exemplary embodiment is omitted.

FIG. 4 is a diagram which exemplifies user interfaces of a cellular phone of the present embodiment. A screen 3 of FIG. 4 is an example of a user interface which shows a list of contents included in the cellular phone 1. In the first exemplary embodiment, the license check communication processing for each content proceeds from the screen 3. On the other hand, in the present embodiment, before the license check communication processing for each content proceeds from the screen 3, the control unit 11 displays a screen allowing a user to select a content provider for which the license check communication processing is to be executed on the liquid crystal display 19. A screen 4 of FIG. 4 shows one example of such a screen. Checkboxes are displayed on the list of the screen 4, which is displayed on the liquid crystal display 19. The user checks the checkbox of the content provider for which the license check communication processing needs to be executed and thus the license check communication processing can be executed for the checked content provider.

To check the checkbox, the user uses the key operating unit 18. That is, the key operating unit 18 and the liquid crystal display 19 function as selecting means. And then, the license check communication processing is executed for the checked content provider (proceed to the screen 1 of FIG. 3).

According to the present embodiment, a user can eliminate a content or a content provider not needed to renew its contract, before executing the license check communication processing, so that unnecessary communication can be omitted and usability is improved.

This application is based upon and claims the benefit of priority from Japanese patent application No. 2007-127973, filed on May 14, 2007, the disclosure of which is incorporated herein in its entirety by reference.

### BRIEF DESCRIPTION OF DRAWINGS

FIG. 1 is a block diagram which shows a configuration example of a cellular phone according to a first exemplary embodiment of the present invention.

FIG. 2 is a flow chart which shows an operation of the cellular phone according to the first exemplary embodiment of the present invention.

FIG. 3 is a drawing which exemplifies user interfaces of the cellular phone according to the first exemplary embodiment of the present invention.

FIG. 4 is a drawing which exemplifies user interfaces of a cellular phone according to a second exemplary embodiment of the present invention.

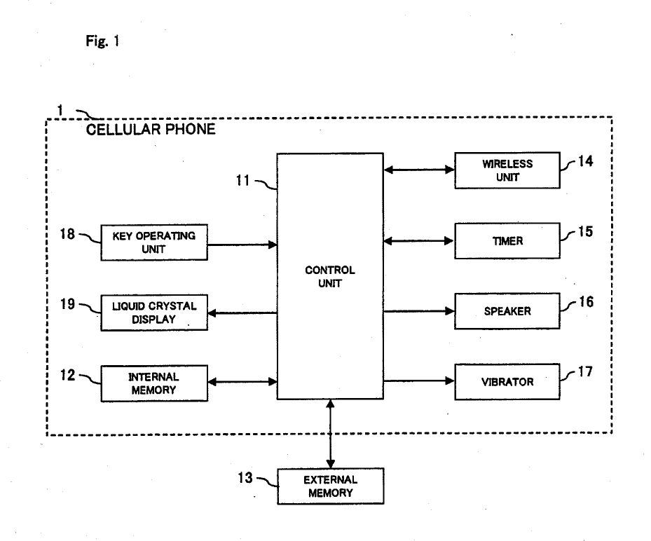

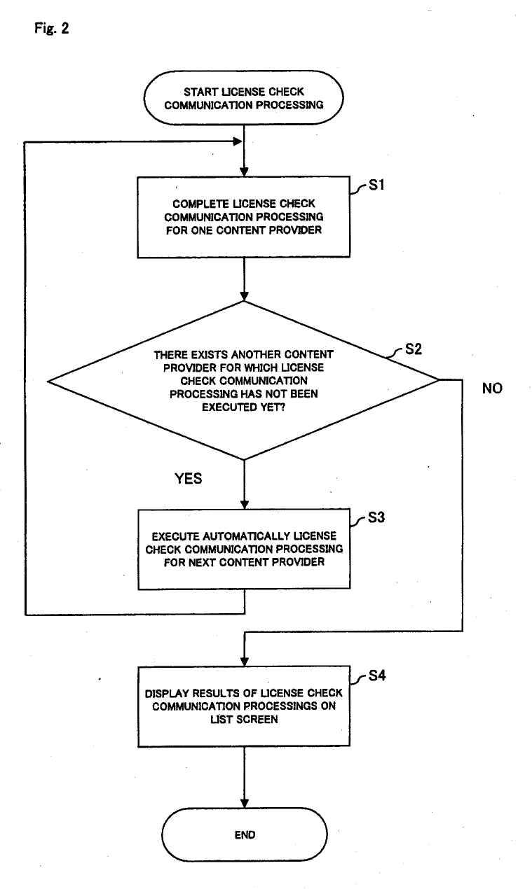

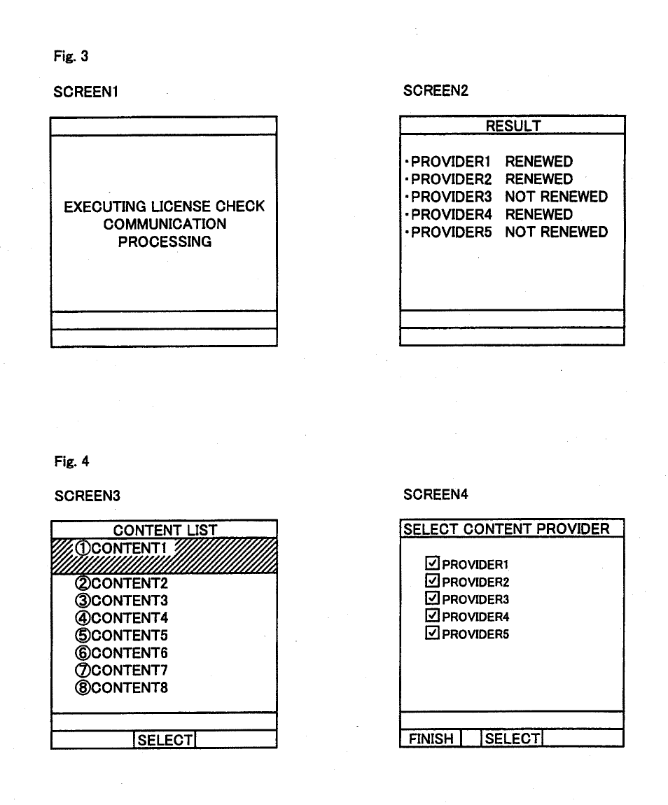

### DENOTATION OF REFERENCE NUMERALS

1 cellular phone
11 control unit
12 internal memory
13 external memory
14 wireless unit
15 timer
16 speaker
17 vibrator
18 key operating unit
19 liquid crystal display

1. A license management device managing one or more licenses of contents, comprising:
a license checking unit that checks out a license of a content by connecting to a content provider of the content via a communication; and
a display unit that displays a processing result of the license checking unit,
wherein, the license checking unit sequentially checks out the licenses to the plurality of content providers and receives the results and
the display unit displays the results of the license checks acquired by the license checking unit in a list form, after the license checking unit completes the license checks to all the content providers.

2. The license management device of claim 1, further comprising:
a selecting unit that allows a user to select the content provider whose license is to be checked out, before the license checking unit sequentially checks out the license to the content provider.

3. The license management device of claim 1, wherein the license checking unit automatically checks out the licenses without requiring a user's operation, when the license checking unit sequentially connects to the plurality of content providers and checks out the licenses.

4. A control method for a license management device managing one or more licenses of contents, comprising:
a license checking step of checking out a license of a content by connecting to a content provider of the content via a communication; and
a display step of displaying a processing result of the license checking step,
wherein, the license checking step sequentially checks out the licenses to the plurality of content providers and receives the results and
the display step displays the results of the license checks acquired by the license checking step in a list form, after the license checking step completes the license checks to all the content providers.

5. The control method for the license management device of claim 4, further comprising:
a selecting step of allowing a user to select the content provider whose license is to be checked out, before the license checking step sequentially checks out the license to the content provider.

6. A computer-readable medium storing a control program which allows a license management device managing one or more licenses of contents to function as
a license checking unit that checks out a license of a content by connecting to a content provider of the content via a communication; and
a display unit that displays a processing result of the license checking unit,
wherein, the control program allows the license management device to execute:
a processing of sequentially checking out the licenses to the plurality of content providers and receiving the results at the license checking unit and
a processing of displaying the results of the license checks acquired by the license checking unit in a list form on the display unit, after the license checking unit completes the license checks to all the content providers.

7. The computer-readable medium storing the control program of claim 6 which allows the license management device to further function as:
a selecting unit that allows a user to select the content provider whose license is to be checked out, before the license checking unit sequentially checks out the license to the content provider.

8. A license management device managing one or more licenses of contents, comprising:
license checking means for checking out a license of a content by connecting to a content provider of the content via a communication; and
display means for displaying a processing result of the license checking means, wherein, the license checking means sequentially checks out the licenses to the plurality of content providers and receives the results and
the display means displays the results of the license checks acquired by the license checking means in a list form, after the license checking means completes the license checks to all the content providers.
